(19) United States
(12) Patent Application Publication
(10) Pub. No.: US 2010/0178826 A1
(43) Pub. Date: Jul. 15, 2010

(54) PADDING MATERIAL WITH INCREASED FIRE SAFETY FOR SEATS IN THE TRANSPORT SECTOR AND FURNITURE SECTOR

(75) Inventors: Werner Lenz, Ludwigshafen (DE); Horst Baumgartl, Mainz (DE); Christof Möck, Mannheim (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE Patents, Trademarks and Licenses, Ludwigshafen (DE)

(21) Appl. No.: 12/377,215

(22) PCT Filed: Aug. 1, 2007
(86) PCT No.: PCT/EP07/57928

§ 371 Date: Feb. 11, 2009

(30) Foreign Application Priority Data
Aug. 11, 2006 (EP) 06118787.8

(51) Int. Cl. B32B 5/18; B32B 3/26; B32B 5/24; B32B 5/26; B32B 7/12

(52) U.S. Cl. 442/224; 428/304.4; 442/370; 442/373; 442/221; 428/316.6; 428/317.7

(57) ABSTRACT

A padding material, comprising

A) one or more layers of an open-cell foam material based on melamine resin with a fire-retardant impregnating material applied, and

B) a incombustible or low-flammability covering material, and

C) a incombustible, supporting substructure,

where the connection between the layers A), B), and C) is the result of force, of interlocking, or of coherent bonding, and also use for furniture, mattresses, mats, and seats in motor vehicles, in rail vehicles, in ships, or in aircraft.

The invention relates to a padding material, comprising

A) one or more layers of an open-cell foam material based on melamine resin with a fire-retardant impregnating material applied, and

B) a incombustible or low-flammability covering material, and

C) a incombustible, supporting substructure,

where the connection between the layers A), B), and C) is the result of force, of interlocking, or of coherent bonding.

Many foam plastics are nowadays used in various embodiments and combinations as padding material in vehicle construction, and in seating, etc. A disadvantage of the most familiar approaches is fire performance, since most flexible foam plastics are classified as flammable to DIN 4102, etc.

Open-cell melamine-resin foam materials, e.g. BASOTECT® from BASF Aktiengesell-schaft, are occasionally used currently as padding material in aircraft seats (US 2003/0186044 A1, WO 2004/052152, EP-A 0 121 049). The flexible open-cell melamine-resin foam material mentioned in said documents is per se classified as having low flammability to DIN 4102, but is often classified as though having normal flammability in conjunction with conventional woven textile coverings.

EP-A 1 146 070 describes open-cell melamine-resin foam materials whose cell structure has been entirely or to some extent coated with an ammonium salt in order to improve fire properties.

However, there are no known incombustible foam materials in seat padding materials based on melamine resins. The publication WO 02/092676 A1describes an incombustible polyether polyol mixture and/or polyester polyol mixture for production of foam material products, in particular of PU foam materials, and GB 2 235 441 A describes a method for insulation with inorganic incombustible foam, using sodium waterglass.

The patent JP 2004050495 A mentions an incombustible panel based on isocyanates and polyol with incombustible outer layers, and its production process. The publication KR 1020020003264 A reveals the subject matter which is in principle similar, where a polystyrene foam has incombustible outer layers composed of a mixture of SiO₂, Al₂O₃, Fe₂O₃, CaO, MgO, and Na₂O.

In the context of seat padding, the document US 000005405178A mentions a fire-resistant vehicle seat: a hybrid approach composed of a supporting foam core and of a fire-resistant outer layer composed of open-cell foam which has been impregnated with a flame retardant. The concluding material is a fire-retardant woven textile. The publication KR 1020040097797 A similarly describes an incombustible structure for chair-seat padding, where the foam core is described as combustible and the double protective covering composed of glass fibers is described as essentially incombustible component.

The German utility model DE 299 02 351 U1 describes a composite system composed of sheets of open-cell melamine-resin foam material and of low-flammability or incombustible nonwovens or woven textiles.

There is no description of a complete approach to padding material giving A2 (incombustible) classification to DIN 4102. This was the motive for developing an appropriate approach to the problem.

It was an object of the present invention to find a padding material based on melamine-resin foam materials (melamine-formaldehyde polycondensation resins) with improved fire properties, in particular meeting the requirements of DIN 4012-A2, i.e. classified as incombustible.

Accordingly, the padding material mentioned in the introduction has been found.

The layers A are formed as core composed of a semifinished product or molding of melamine-resin foam material, a flexible and completely or partially open-cell foam material composed preferably of melamine-formaldehyde polycondensate with filigree three-dimensional network structure. Its density is from 3 to 50 g/l, preferably from 6 to 9 g/l.

As an alternative, it is also possible to use open-cell flexible polyurethane foam materials, flexible foam materials composed of melamine-urea-formaldehyde resins, and of flexibilized urea-formaldehyde resins.

A fire-retardant impregnating material has been applied to the layers A). This material can comprise inorganic compounds, such as hydroxides and oxides of the 2nd and 3rd main group of the periodic table of the elements, in particular aluminum hydroxide and magnesium hydroxide, and phosphates of the 1st, 2nd, and 3rd main group, in particular the (mono-, meta-, or poly)phosphates of sodium, of potassium, and of ammonium, or else the (alumino)silicates of sodium and of potassium. To this end, in a downstream wet-impregnation process known from the woven textile industry, the semifinished product made from foam material or the molding made from foam material, composed of the open-cell foam material based on a melamine resin is applied to the foam material with the inorganic compounds in the form of aqueous solution or in the form of suspension—but preferably in the form of aqueous foam, and then the excess liquid is removed by squeezing in a mangle (pad-mangling), and then the foam material, which is still moist, is dried by hot air, microwave, or IR radiation.

It is also possible to use polyurethane impregnating compositions with high proportions of flame retardant, alongside these inorganically based impregnating compositions.

By virtue of the fire-retardant impregnating material it is possible, as a function of material and concentration, to raise the original density in the dried state by a factor of at least 2, preferably from 4 to 15. The density of the open-cell foam material based on a melamine resin and provided with the fire-retardant impregnating material can therefore generally be from 6 to 750 g/l. The hardness of such an impregnated foam material whose density is 72 g/l, based on Basotect, with density of 9 g/l prior to impregnation, is above 300N (measured after 30 s), measured to ISO 2439, method B, with compression of 40%.

In addition to the fire-retardant impregnating material, the open-cell melamine resin foam material can be treated with a hydrophobicizer and/or oleophobicizer, for example with a silicone resin or fluorocarbon resin.

Suitable incombustible or low-flammability covering material B) comprises single- or multi-ply woven textiles, nonwovens, or foils composed of materials incombustible to DIN 4102, preferably glass fibers, mineral fibers, carbon fibers, aramid fibers, and very highly flame-retardant woven textile fibers.

In order to promote the cleaning of such seat padding, the covering material B) can, if necessary, be rendered dirt-repellent via a hydrophobic or hydro- and oleophobic coating, e.g. by established woven textile-industry processes with silicone resins, and with fluorocarbon resins.

A suitable method for minimizing soiling of the coverings via electrostatically bound dust particles is addition of antistatic agents, in particular of cationic, anionic, and nonionic surfactants, which can be applied via spraying, foam-application, or immersion.

The supporting substructure C) is likewise composed of a material incombustible to DIN 4102. Metals are particularly suitable, e.g. iron, steel, and in particular lightweight metals, such as aluminum, magnesium, and alloys thereof. The substructure has been designed to resist deformation and to be stable, since it assumes the function of support.

In order to improve comfort and resilience, an elastic or visco-elastic spring core D) composed of an incombustible metallic or polymeric material to DIN 4102, e.g. spring steel or plastic, such as glass fiber-reinforced polyester, can be introduced between the impregnated foam core and the substructure.

The covering can cover the foam material core partially or on all sides. The connection between covering and foam material core or frame substructure can take the form of a force fit and/or coherent bond and/or interlock.

Direct connection to the impregnated foam material core can take the form of a force fit, by using a suitable technique to stretch the covering over the foam core or the substructure. The fastening method used can involve cords, spring elements, or preferably metal staples, which are fixed in one or more fiber-reinforced concrete panels or, respectively, strips thereof fastened to the substructure. By way of example, Pericolor® from Eternit AG is classified as incombustible to DIN 4102-A2. Other incombustible fiber-reinforced concrete materials are also generally suitable for the fixing process. An advantage here is that these connections can easily be released in the event of replacement of padding cores or repair.

A coherent connection is permitted via partial or full-surface adhesive bonding of the covering to the core of foam material. The adhesive can be applied here over the entire surface or over part of the surface, or locally. Incombustible adhesives based on silicate or on phosphate are suitable, with flexibilizers. The impression hardness of these composites can be controlled by way of the adhesive material, adhesive application thickness, and the method of application. This embodiment is likewise advantageous for surface appearance (freedom from creasing).

Interlock connections can be brought about, for example, by needling of the coverings with the core of foam material. The advantage of this process is that there is no need for use of further materials affecting fire performance.

A particular advantage is that, by virtue of the materials used, these incombustible padding cores remain deformable, and that low densities can still be achieved. The high service temperatures are a further advantage. Additional introduction of silicone resins or of fluorocarbon resins or the like into the impregnating solution can give hydrophobic and oleophobic modification of the cores of foam material, and this represents an additional advantage when the seat padding is cleaned.

The inventive padding material is particularly suitable for furniture, mattresses, mats, and seats in motor vehicles, in rail vehicles, in ships, or in aircraft.

1. A padding material, comprising
A) one or more layers of an open-cell foam material based on melamine resin with an applied fire-retardant impregnating material comprising aluminum hydroxide, magnesium hydroxide, or sodium silicates, and
B) an incombustible or low-flammability covering material, and
C) an incombustible, supporting substructure,
where the connection between the layers A), B), and C) is the result of force, of interlocking, or of coherent bonding.

2. The padding material according to claim 1, wherein the one or more layers A) comprise a melamine-formaldehyde polycondensation resin and their density, with impregnating material, is in the range from 6 to 750 g/l.

3. The padding material according to claim 1, wherein the hardness of the one or more layers A) at density >70 g/l is above 300 N according to ISO 2439, method B with 40% compression.

4. (canceled)

5. The padding material according to claim 1, wherein the covering material B) comprises single- or multi-ply nonwovens or woven textiles comprising glass fibers or mineral fibers.

6. The padding material according to claim 1, wherein the substructure C) comprises iron, steel, aluminum, magnesium, or their alloys.

7. The padding material according to claim 1, wherein between the one or more layers A) and the substructure C) an elastic or visco-elastic spring core D) has been introduced.

8. The padding material according to claim 1, wherein the one or more layers A) and the covering material B) have been connected to one another, over the entire surface or over part of the surface or locally, by a coherent bond with an adhesive based on silicates or on phosphates.

9. Furniture, mattresses, mats, and seats in motor vehicles, in rail vehicles, in ships, or in aircraft, comprising the padding material according to claim 1.

10. The padding material according to claim 2, wherein the hardness of the one or more layers A) at density >70 g/l is above 300 N according to ISO 2439, method B with 40% compression.

11. The padding material according to claim 2, wherein the covering material B) comprises single- or multi-ply nonwovens or woven textiles comprising glass fibers or mineral fibers.

12. The padding material according to claim 3, wherein the covering material B) comprises single- or multi-ply nonwovens or woven textiles comprising glass fibers or mineral fibers.

13. The padding material according to claim 2, wherein the substructure C) comprises iron, steel, aluminum, magnesium, or their alloys.

14. The padding material according to claim 3, wherein the substructure C) comprises iron, steel, aluminum, magnesium, or their alloys.

15. The padding material according to claim 2, wherein between the one or more layers A) and the substructure C) an elastic or visco-elastic spring core D) has been introduced.

16. The padding material according to claim 3, wherein between the one or more layers A) and the substructure C) an elastic or visco-elastic spring core D) has been introduced.

17. The padding material according to claim 5, wherein between the one or more layers A) and the substructure C) an elastic or visco-elastic spring core D) has been introduced.

18. The padding material according to claim 2, wherein the one or more layers A) and the covering material B) have been connected to one another, over the entire surface or over part of the surface or locally, by a coherent bond with an adhesive based on silicates or on phosphates.

19. The padding material according to claim 3, wherein the one or more layers A) and the covering material B) have been connected to one another, over the entire surface or over part of the surface or locally, by a coherent bond with an adhesive based on silicates or on phosphates.

20. The padding material according to claim 5, wherein the one or more layers A) and the covering material B) have been connected to one another, over the entire surface or over part of the surface or locally, by a coherent bond with an adhesive based on silicates or on phosphates.

21. The padding material according to claim 6, wherein the one or more layers A) and the covering material B) have been connected to one another, over the entire surface or over part of the surface or locally, by a coherent bond with an adhesive based on silicates or on phosphates.
